(19) United States
(12) Patent Application Publication
(10) Pub. No.: US 2019/0201909 A1
(43) Pub. Date: Jul. 4, 2019

(54) ECCENTRIC ASSEMBLY FOR A CONE CRUSHER

(71) Applicant: TRIO ENGINEERED PRODUCTS, INC., Irwindale, CA (US)

(72) Inventors: Kurt O'Bryan, Waukesha, WI (US); Michael James Noble, Troy, MO (US)

(21) Appl. No.: 16/333,025

(22) PCT Filed: Sep. 13, 2017
(86) PCT No.: PCT/US17/51429

§ 371 Date: Mar. 13, 2019

Related U.S. Application Data
(60) Provisional application No. 62/393,908, filed on Sep. 13, 2016.

(30) Foreign Application Priority Data
Oct. 16, 2016 (AU) 2016904065

(51) Int. Cl. B02C 2/04

(52) U.S. Cl. CPC B02C 2/042

(57) ABSTRACT

An eccentric assembly for a crusher is disclosed. The eccentric assembly attaches both an eccentric and a counterweight to an underlying rotatable gear that supplies rotational force to the assembly. The eccentric includes an eccentric barrel and an eccentric flange, and the sides of the eccentric are disproportionately weighted. Similarly, the counterweight is disproportionately weighted in an inverse configuration to the eccentric. The eccentric and the counterweight are bolted, pinned, keyed, screwed, nailed, or otherwise fastened to an upper side of the gear. Additionally, the eccentric and the gear both have fluid channels disposed therein for transporting lubricant, such as oil, through the crusher. In particular, the gear may include internally bored fluid passages or external drains for receiving and dispelling the lubricant.

### CROSS-REFERENCE TO RELATED APPLICATIONS

This application claims priority to U.S. Patent Provisional Application No. 62/393,908, filed Sep. 13, 2016 and entitled “An Eccentric Assembly for a Cone Crusher,” the entire disclosure of which is hereby incorporated herein by reference for all intents and purposes.

### BACKGROUND

A crusher is a machine designed to reduce large raw materials (such as a rock ore) into smaller rocks, gravel, or rock dust so that particulates of different composition can be separated by beneficiation processes. One particular type of crusher is a cone crusher. Cone crushers crush rock between two conical surfaces that generally include a lower movable surface (the mantle) and one or more concave liners positioned above the movable surface.

Crushing action is achieved by the eccentric movement of the head. A mantle is connected to this head, providing a base for rock to sit. The mantle is one of the actual crushing surfaces in the cone crusher. The mantle moves in a rotary pattern driven by a motor to crush rock between itself and a concave liner. Though, the mantle does not actually rotate. Instead, it moves in a circular pattern due to an eccentric lobe around a main shaft of the cone crusher. The head is what the mantle is mounted to and is typically supported by the eccentric assembly and underlying bushings or bearings that are usually placed off of a center axis of the crusher. One or more gears usually drive the eccentric lobe through the counter shaft, rotating a housing that supports the mantle. This rotating housing provides rotary motion to the cone crusher, which in turn enables the mantle to apply consistent temporary pressure to materials being fed into the crusher, thereby crushing the material to a size small enough to escape the mantle-bowl crushing portion.

### SUMMARY

A first aspect is directed to an eccentric assembly for providing oscillating rotation within a crusher. The eccentric assembly includes a gear rotatable by force supplied from a motor; an eccentric affixed to the gear having an eccentric barrel with a wider barrel portion and a narrower barrel portion; and a counterweight affixed to the gear on a same side that the eccentric is affixed. The gear, the eccentric, and the counterweight are positioned around a central rotational axis of the crusher.

In one aspect, the eccentric comprises a first set of one or more fluid channels for receiving lubricant and conveying the lubricant to the gear.

In one aspect, the fluid channels are internal to the eccentric.

In one aspect, the gear includes a second set of one or more fluid channels for dispelling the lubricant received from the eccentric.

In one aspect, an aggregate fluid channel is disposed through the eccentric and the gear.

In one aspect, the aggregate fluid channel is configured to the dispel the lubricant vertically down the eccentric and out of one or more fluid channel outlets of the gear.

Another aspect includes a feed plate assembly of the crusher having a first width and a socket liner attached to the feed plate assembly having a second width greater than the first width of the feed plate assembly.

Another aspect includes a thrust bushing attached to an opposite side of the gear than a side where the eccentric is attached.

In another aspect, the eccentric is affixed to the gear using pins, bolts, or keys.

Another aspect is directed to a crusher with a hopper for receiving rock material to crush; a bowl within the hopper; a mantle for applying necessary pressure to the rock against the bowl; and an eccentric assembly for providing rotational force to create an oscillating crushing force between the mantle and the bowl. The eccentric assembly includes a gear rotatable by force supplied from a motor, an eccentric affixed to the gear, and a counterweight affixed to the gear on a same side that the eccentric is affixed.

In another aspect, the aggregate fluid channel is disposed through the eccentric and the gear for conveying lubricant through the crusher.

In another aspect, the eccentric includes an eccentric barrel and an eccentric flange. The aggregate fluid channel includes a first fluid channel disposed through the eccentric barrel and the eccentric flange of the eccentric, into an upper side of the gear to which the eccentric is affixed, through the gear, and out of the gear.

Another aspect is directed to an eccentric assembly for providing oscillating rotation within a crusher. The eccentric assembly includes a gear rotatable by force supplied from a motor, the comprising a first fluid channel disposed within the gear; an eccentric attached to the gear having a second fluid channel. An aggregate fluid channel is formed from the first fluid channel of the gear and the second fluid channel of the eccentric upon attachment of the eccentric to the gear.

In another aspect, the eccentric includes an eccentric barrel with one wide side and one narrow side, and the second fluid channel is disposed within the wide side of the eccentric barrel.

In another aspect, the gear includes one or more drains for receiving lubricant from the second fluid channel of the eccentric and dispelling the lubricant away from the gear.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1. is an exploded perspective view of an eccentric assembly for a crusher, according to one example.

FIG. 2 is an exploded side view of an eccentric assembly for a crusher, according to one example.

FIG. 3 is a cross-sectional view of a crusher with an eccentric assembly, according to one example.

FIGS. 4-5 are cross-sectional views showing an assembly of an eccentric, a counterweight, and a gear of a crusher with an eccentric assembly, according to some examples.

FIG. 6 is a perspective view a gear for a crusher that is designed to drain lubricants, according to one example.

### DETAILED DESCRIPTION

Embodiments disclosed herein generally relate to an eccentric assembly for a cone crusher. Generally, the various examples are disclosed in reference to a generic “crusher,” which may take the form of a cone crusher or other type of industrial crusher that uses a eccentric-counterweight rotational driver for providing crushing force. More specifically, various examples disclose an eccentric assembly with a circular gear that receives power from an external motor. Both an eccentric and a counterweight are attached to the gear, in some examples. Also, in various examples, the eccentric and the gear include fluid channels for conveying lubricant, such as oil, for the crusher.

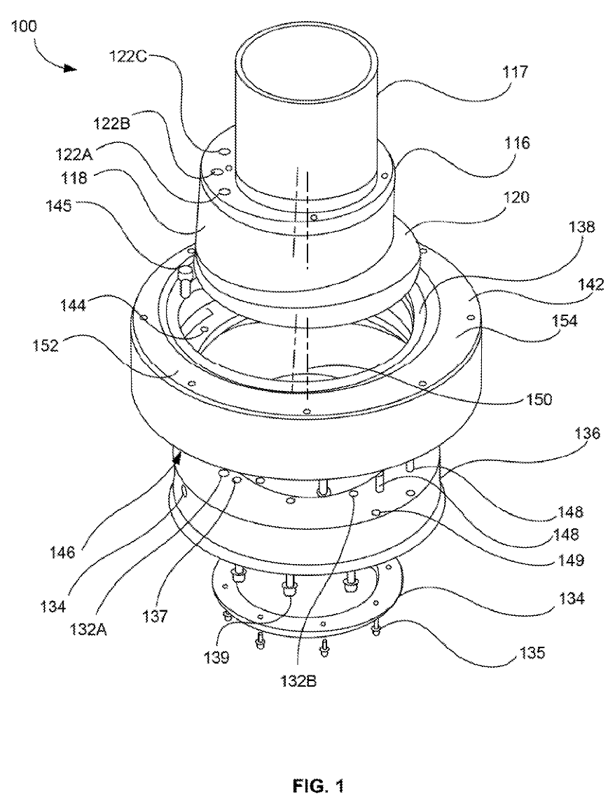

FIG. 1. is an exploded perspective view of an eccentric assembly 100 for a cone crusher, according to one example. The eccentric assembly 100 includes an eccentric 116; an eccentric bushing; a counterweight 138; a counterweight guard 142; one or more gears 136; a thrust bushing 134; dowel pins 148; various holes 137, 146, 144, and 149; and various bolts 135, 139, and 145. In some examples, the eccentric 116 includes a top portion with the eccentric bushing 117 and a lower portion having circular off-centered (with respect to a longitudinal central axis 150 of a cone crusher's shaft) weighted portions that, at least partially, fit within the counterweight 138 and its exterior counterweight guard 142. More specifically, in some examples, the eccentric 116 includes the eccentric bushing 117, an eccentric barrel 118, and an eccentric flange 120. The eccentric flange 120 of the eccentric 116 is attached directly to the gear 136. Attachment may be made using dowel pins 148 that fit within holes 137, screws, keys, fasteners, magnets, or any other way ways for mechanically coupling two metallic pieces together.

Along with the eccentric 116, the counterweight 138 is also attached to the gear 136. Attachment of the two may be made by bolts, screws, pins, keys, dowels, magnets, or the like. As shown, in one example, two dowel pins 148 are used on the heavy side 154 of the counterweight 138 to attach the counterweight 138 to the gear 136. In one particular example, the counterweight 138 is attached to the gear 136 with four socket head cap bolts 145. The counterweight 138 includes a narrower, lighter, thinner side 152 that is positioned below an inversely wider, thicker, and heavier (relative to the thinner side 152) side of the eccentric barrel 118. Similarly, the counterweight 138 includes a wider, thicker, and heavier side 154 that is positioned circumferentially opposite a narrower, thinner, and lighter (relative to side 154) of the eccentric barrel 118. These offsetting portions of the eccentric barrel 118 and the counterweight 138 enable the two to counterbalance each other so that the eccentric assembly 100 does not spiral off of the axis 150 when rotating.

Thus, the gear 136 may have both the eccentric 116 and the counterweight 138 attached in various examples. Alternatively, either the eccentric 116 or the counterweight 138 may be attached to the gear 136. In some examples, the eccentric 116 and the counterweight 138 are attached to the top of the gear 136, meaning the face of the gear 136 pointing upward toward the eccentric 116. Alternative examples have the eccentric 116 attached to the top face of the gear 136 and the counterweight 138 may be attached to either a side or bottom face of the gear 136. Moreover, in some examples, the eccentric 116 may be directly attached to the gear 136, but the counterweight may be attached to the gear 136 indirectly through an intermediary flange, shaft, ring, or other component. For example, the counterweight 138 may first be attached to an arcuate metal ring that is positioned atop and is attached to the gear 136.

In some examples, a first series of gear portion attachment formations may be used for attaching the counterweight 138 to the gear 136. In one example, a set of four blind threaded holes 146 (not visible but indicated by arrow in FIG. 1) and two blind holes 149 align to receive fastening screws, bolts, keys, nails, or other types of connectors. In one example, counterweight 138 is attached to gear 136 by way of four bolts 145 that pass through holes 144 to be received in threaded holes 146. In some examples, two dowel pins 148 position the counterweight 138 in its correct orientation with respect to the gear 136 by being inserted, and thus mating with, holes 149. Screws, fasteners, magnets, keys, or other fasteners may alternatively be used in lieu of the dowel pins 148.

The gear 136 further includes a second set of gear portion attachment formations for attaching the eccentric 116 to gear 136 in the form of a series of through holes 137. In some examples, holes 137 correspond with the locations of a series of blind threaded holes 147 (not visible) provided on the bottom face (i.e., pointing toward the gear 136) of eccentric 116. Any of the other disclosed fasteners (e.g., keys, pins, fasteners, screws, nails, magnets, or the like) may be alternatively used. Such examples have the eccentric 116 attached to the gear 136 by way of bolts 139 (or, alternatively, pins, dowels, screws, nails, or the like) passing through holes 137 to be received in threaded holes 147.

Underneath the gear 136, a thrust bushing 134 is attached to the gear 136 using bolts 135 (or any of the aforesaid connectors). In some examples, the thrust bushing 134 is attached to the opposite side of the gear 136 than the side where the eccentric 116 and/or the counterweight 138 are attached.

The eccentric assembly 100 is assembled by attaching the counterweight 138 to the gear and then attaching the eccentric 116 to the gear, as described above. Once assembled, the eccentric assembly 100 may be installed into a cone crusher (or any other type of crusher) by being dropped into a main shaft of the crusher such that with the eccentric bush 117 is disposed between the inside surface of the eccentric 116 and the main shaft.

The eccentric assembly 100 is also configured to aid in the conveyance of lubrication (e.g., oil) in a cone crusher. In this vein, the eccentric 116 has fluid channels 122A-C bored, drilled, punched, or otherwise hollowed out for passing lubricant from the eccentric 116 down to and through the gear 136, which includes fluid channels 132A-B of its own. The fluid channels 122A-C are passages in the eccentric 116 from the eccentric barrel 118 through the eccentric flange 120 for lubricant to flow into the eccentric barrel 118 and out of the eccentric flange 120 down toward the gear 136. Though shown originating in the top of the eccentric barrel 118, the fluid channels 122A-C may alternatively have inlets positioned on the sides of the eccentric barrel 118, along the eccentric flange 120, or along the eccentric bushing 117. Alternatively, the fluid channels may take the form of grooves in the exterior or interior of the eccentric 116, for example along the outer or inner walls of the eccentric barrel 118 or eccentric flange 120—instead of through channels that are internal to the eccentric barrel 118 and flange 120. The fluid channels of the eccentric 116 may be configured in other patterns without departing from the spirit of the examples disclosed herein.

Similarly, the gear 136 includes fluid channels 132A-B and 134 that are hollowed out or grooved—either internally in the gear 136 or externally along a wall of the gear 136—for receiving the lubrication flowing through or down the eccentric 116. Specifically, in one example, vertical fluid channels 132A-B are positioned on the top face of the gear 136 for receiving lubricant that has flows down through the fluid channels 122A-C in the eccentric 116, and side fluid channels 134 are positioned on the exterior of gear 1365, pointing radially outward. The depicted fluid channels 132 in the gear 136 run vertically from the top of the gear 136 internally down through a portion of the gear, and then fluid channels 134 that run horizontally or at a decline through the gear 136 out to a side wall. Though only one is shown, the gear may have several side fluid channels 134 positioned around the gear 136, or only a portion of the gear 136 (e.g., along ¼, ⅓, ½, or the like of the outside circumference).

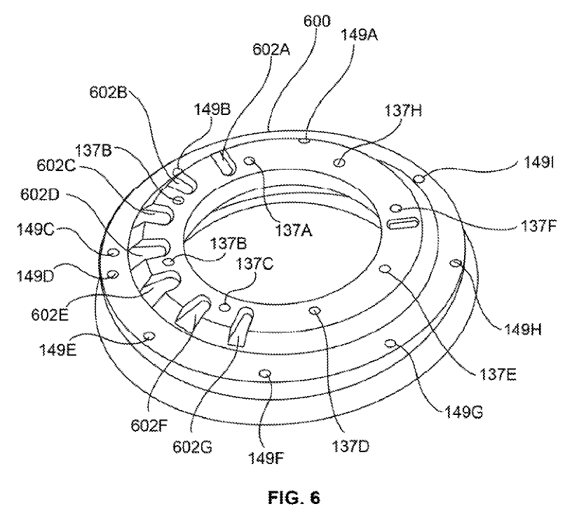

In alternative examples, as shown in FIG. 6 and discussed in more detail below, fluid channels 602A-G are positioned atop a portion (e.g., one half) of the gear 136, opening up radially outward, and potentially at a decline, away from the gear 136. Further still, some examples include fluid channels 134 that flow completely vertically from the top of the gear 136 to the bottom of the gear 136. The fluid channels 132 of the gear 136 may be configured in other patterns without departing from the spirit of the examples disclosed herein.

The fluid channels 132 and 134 in the gear 136 and the fluid channels 122 in the eccentric together form an “aggregate flow channel” to pass fluid through the eccentric assembly. Alternatively, lubricant may be pushed the other way through the aggregate flow path created by the fluid channels 134, 132A-B, and 122A-C, into the gear 136 and up through the eccentric 117. For example, side fluid channels 134 of the gear 136 may receive lubricant that is pumped horizontally toward vertical fluid channels 132A-B of the gear 136 and up through and out of fluid channels 122A-C in the eccentric 116.

Using the eccentric 116 and the gear 136 as passageways of lubricant enables a crusher to be smaller in size, because additional fluid channels outside of the parts already in the crusher are not needed. So the eccentric assembly 100 is used in a way that has not been conventionally done, to move lubricant through the crusher. Moreover, the shaft of the cone crusher may be made larger because less room is needed in the crusher's components for conveying lubricant, due to the fact that lubricant is efficiently passing through components of the eccentric assembly 100.

When assembled, the counterweight 138 and the counterweight guard 142 are positioned around the lower portion of the eccentric 116, such as around the eccentric flange 120 and part of the eccentric barrel 118. In some example, the counterweight 138 is attached directly to the gear 136, for example along the top of the gear 136 (i.e., the face of the gear 136 pointing toward the eccentric 116). Other examples attach the counterweight 138 to an intermediary connector ring that is attached to the gear 136, thereby indirectly coupling the counterweight 138 to the gear 136. Additionally or alternatively, the counterweight guard 142 may be attached to the gear 136. Affixing the counterweight 138 to the gear 136 enables a larger gear 136 to be used, which can hold up to wear-and-tear better.

In operation, the eccentric 116 and the counterweight 138 rotate to gyrate and a mantle of a crusher in an oscillating fashion toward and away from parts of the crusher's bowl. The gear 136 provides the mechanical power from a motor or pump to rotationally move the eccentric assembly 100. The off-center weighting of the eccentric 116 and the counterweight 138 translate the rotation movement of the gear 136 into an oscillating crushing motion that enables the mantle to crush rocks against a bowl and then release the crushed rocks either for additional crushing or movement to another mining procedure.

The eccentric assembly 100 provides efficient communication of lubricant through the eccentric 116 and the gear 136, thereby eliminating the need to have additional fluid channels. As a result, this reduces the necessary footprint of the eccentric assembly 100 in the crusher, which allows the crusher to be smaller in size. Additionally, attachment of the counterweight 138 and the eccentric 116 to the gear 136, which is not found in any conventional eccentric assembly, provides added stability for eccentric assembly 100 and allows the gear 136 to be strategically positioned inside the crusher in a manner that maximizes the torque and rotational movement provided by the gear 136. For instance, the gear 136 does not need to be connected to over internal gears that may wear down or add a level of rotational friction or loss to the eccentric assembly 100.

Moreover, the gear 136 and/or the eccentric 116 may be made out of different materials that conventional assemblies that use forged steel. For example, any of the gear 136, counterweight 138, or eccentric 116 may be made out of aluminum or tungsten carbide, which is considerably lighter than conventional systems' steel. Using lighter materials like aluminum or tungsten carbide allows the eccentric assembly 100, and its cone crusher, to be lighter in weight.

The eccentric assembly 100 enables use of a larger diameter main shaft than has been traditionally used. The eccentric assembly 100 allows sufficient space to attach the counterweight 138 in a maximum throw eccentric design while keeping the primary internal dimensions of the eccentric assembly 100 unchanged. The maximum throw of the eccentric assembly 100 provides for increased throughput with overall higher productivity. Also, a larger gear 136 may be used because it can take the shape of the eccentric 116, and thus the crusher may only require the single gear 136 to provide rotational power from a motor or pump to the eccentric assembly 100. Moreover, the lubrication fluid channels flowing through the eccentric 117 and the gear 136 provide a smaller footprint for the eccentric assembly 100 and repurpose components conventionally used for supplying mechanical force to also providing lubrication conveyance.

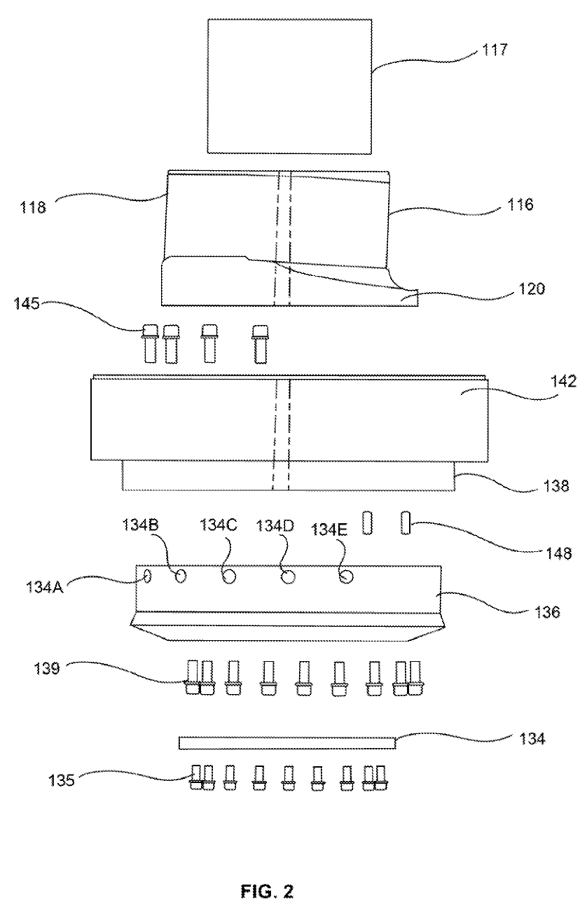

FIG. 2 is an exploded side view of an eccentric assembly 100 for a cone crusher, according to one example. As shown, the eccentric assembly 100 includes an eccentric bushing 117, an eccentric 116, a counterweight guard 142, a counterweight 138, a gear 136, and a thrust bear 134. These component parts are held together using the illustrated bolts 145, 139, and 135. Other examples use keys, bolts, screws, magnets, or the like instead of the dowel pins 148, bolts 145, or bolts 135. In some examples, the eccentric 116 is attached to the gear 136 using the dowel pins 148. Moreover, in some examples, the counterweight 138 is bolted to a top side of the gear 136 using bolts 145, along the thinner side 152 (not shown) of the counterweight 138. On the bottom of the gear 136, the thrust bushing 134 is attached by way of bolts 135.

Though not shown in the side view of FIG. 2, the eccentric 116 includes internal fluid channels 122A-C that pass through the eccentric barrel 118 and/or the eccentric flange 120 down to the connected gear 136. As previously discussed, the gear 136 is equipped with its own vertical fluid channels 132A-B and side fluid channels 134A-E for moving the lubricant received from the eccentric out of the gear 136 and toward other parts of the crusher. Alternatively, lubricant may be pushed the other way through the aggregate flow path created by the fluid channels 134A-E, 132A-B, and 122A-C, through the gear 136 and up through the eccentric 117. For example, side fluid channels 134A-E of the gear 136 may receive lubricant that is pumped horizontally toward vertical fluid channels 132A-B of the gear 136 and up through and out of fluid channels 122A-C in the eccentric 116.

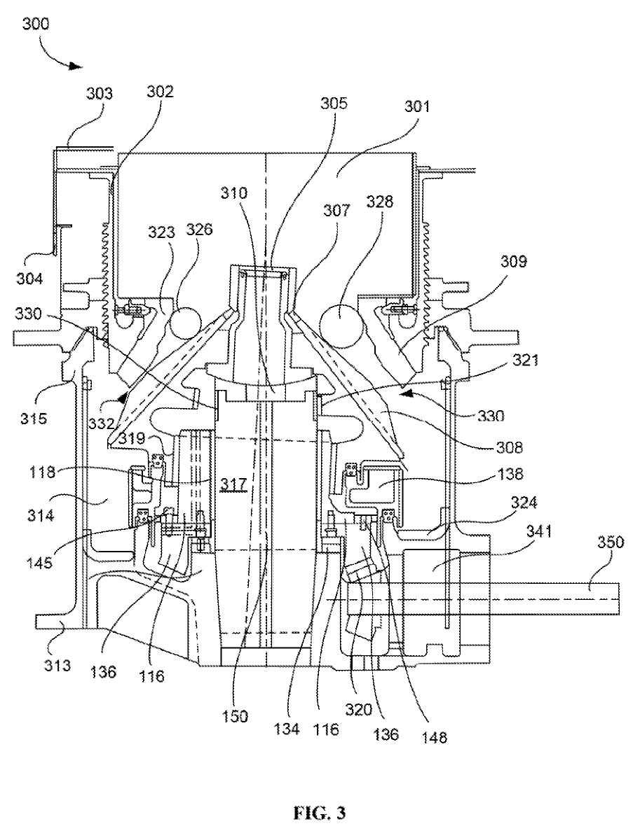

FIG. 3 is a cross-sectional view of a cone crusher 300 with an eccentric assembly 100, according to one example. The cone crusher 300 includes a hopper assembly 301, a bowl 302, an adjustment cap 303, a drive ring 304, feed plate assembly 305, a torch ring 307, a mantle 308, a bowl liner 309, a socket liner 310, a main frame 313, a main frame liner 314, a main frame seat liner 315, a main shaft 317, a lower bush 319, a drive pinion 320, an upper bush 321, a wedge 323, a socket 330, an arm guard 324, varying material passageways 330 and 330, a countershaft 341, and a shaft 350. Additionally, the eccentric assembly 100 is positioned along the main shaft 317 under the mantle 308, the socket 321, the socket liner 310. The eccentric assembly 100 includes an eccentric 116 and a counterweight 138 that are both connected to an upper side of the gear 136.

Specifically, in some examples, the counterweight 138 and the eccentric 116 are each directly connected to the gear 136, specifically to the top side (or, in other examples, to a side) of the gear 136. The gear 136 engages the shaft 350 (e.g., though a series of gear teeth) to receive rotational force to supplied by a motor or pump (not shown). The countershaft 351 may be used to absorb axial forces caused from other gear sets. In some examples, the eccentric bush 118 is disposed between the inner surface of the eccentric 116 and the main shaft 317. The bush known as the lower head bush 319 is disposed between the outer surface of the eccentric 116 and the mantle 308.

A pulley 18 is driven by an engine or motor (not shown) rotating the drive pinion 20 that engages with teeth of the gear 136 mounted at the underside of the eccentric 116 and the counterweight 138. The outer surface of the eccentric 116 is in the shape of a cylinder whose central axis is offset from the central axis of the main shaft 317. The eccentric 116 operates, in some examples, as a type of cam. Rotation of the eccentric 116 causes the mantle 308 in a circular oscillatory fashion. This oscillating movement causes rocks 326 and 328 fed into the hopper assembly 301 to become crushed in between a wear-resistant head liner of the mantle 308 and the wear-resistant bowl liner 309 of the bowl 302. As the rock breaks up into smaller pieces, the crushed rock falls downwardly under the influence of gravity to either be crushed again at a narrower region between the mantle 308 and the bowl 302 or to fall through narrow opening 332, if sufficiently small enough. The size of rock pieces that are permitted to leave the cone crusher 300 are determined by the clearance between the bowl liner mantle 308 and the bowl 302, and this clearance (i.e., opening 332) may be adjusted to achieve a desired particulate size.

The external motor or pump rotates the shaft 350, and that rotational motion is conveyed to the gear 136. In turn, the gear 136 rotates, thereby rotating the eccentric 116 and the counterweight 138 to move the mantle 308 toward and away from the wedge 323. The rocks are crushed, either once or multiple times as they fall down the mantle 308, between the wedge 323 and the mantle 308 into particulate sizes in proportion to an opening 332 where the crushed rock can fall through for other mining steps. With the eccentric 116 and the counterweight 138 both connected to the gear 136, the cone crusher 300 can have a larger shaft 317 than conventional crushers.

In some examples, the socket liner 310 is mounted to the top of the main shaft 350 over an intermediate socket 330, which is an interference fit with the top of the main shaft 350. The socket 330 supports the mantle 308 and, in some examples, has a concave upper surface to accommodate the oscillatory movement from the eccentric assembly 100. The upper bush 321 bears against the outer surface of the socket 330.

Conventionally, in other crusher designs, the socket liner and socket are larger than the bore of the eccentric assembly. As a result, eccentric assemblies in conventional crushers cannot be removed without first removing the socket and socket liner. Whereas, crusher 300 includes a new design that, in some examples, combines the socket 330 and the socket liner 310 into a single piece that is fitted on top of the main shaft 317. In some examples, a diameter of the single piece with the socket liner 310 and the socket 330 is equal, or substantially equal, to the diameter of the main shaft 317, and the diameter is slightly smaller than the inner bore of the eccentric 116. This enables the eccentric assembly 100 to be easily removed by being lifted over the single piece with the socket liner 310 and the socket 330 without disassembly thereof.

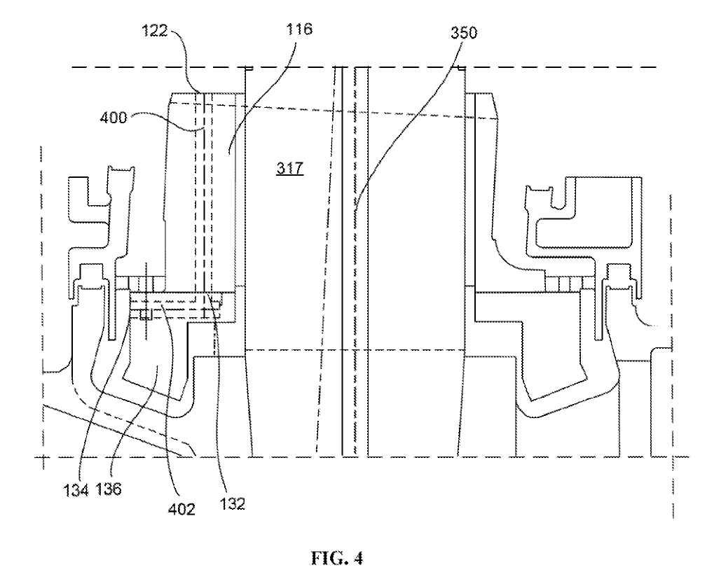

In some examples, a fluid pathway for lubricant is created through the eccentric 116 and the gear 136, as illustrated by internal dotted lines through both, as shown in more detail in the expanded view of FIG. 4. Looking closer at FIG. 4, an aggregate fluid channel 400 is created through the eccentric 116 and the gear 136. Lubricant may enter the aggregate fluid channel 400 at the inlet of fluid channel 122, fall vertically toward the gear 136, and then be driven horizontally along pathway 402 and out of the fluid channel 134 in the gear 136. Centrifugal force due to the rotational movement of the gear 136 in some examples assists in propelling the lubricant out of the horizontal fluid channel 134. Other examples may use a side fluid channel 134 in the gear 136 with a declination—instead of a horizontal pathway—to expel the lubricant. Moreover, other examples may use the aggregate fluid channel 400 in the reverse, pumping lubricant into the fluid channel 134 of the gear 136 and up through the fluid channel 122 of the eccentric 116.

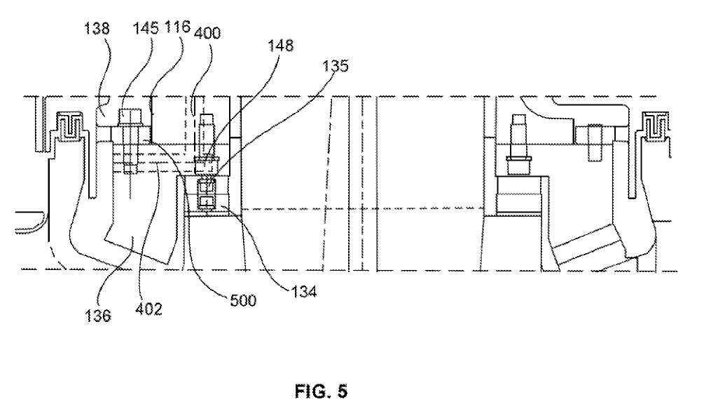

FIG. 5 is an expanded view of the eccentric assembly 100, according to one example. As is shown, the eccentric 116 and the counterweight 138 are attached to the gear 136. In some examples, the counterweight 138 is indirectly bolted, using bolt 145, through intermediary ring 500 and into the gear 136. In some examples, the intermediary ring is a separate ring from the counterweight 138. In other examples, the intermediary ring 500 is part of the counterweight 138, meaning that the counterweight 138 is directly affixed to the gear 136. The eccentric 116 is also attached to the gear 136. In the depicted example, the eccentric 116 is connected to the gear 136 using pin 148. Other examples use keys, screws, bolts, nails, magnets, or any other type of fastener.

The thrust bushing 134 is attached to the underside of the gear 136 pointing away from the eccentric 116 using, for example, bolts 135. The thrust bushing 134 may also be secured to underlying parts of the cone crusher to stabilize installation of the eccentric assembly 100. Lubrication may be passed down from the side fluid channels 134 of the gear 136 to the thrust bushing 134.

Again, as previously discussed, an aggregate fluid channel 400 is created inside or along walls of the eccentric 116 and the gear 136. While some examples move lubricant internally through the gear 136, other examples may drain lubricant along outer edges of the gear 13.

FIG. 6 is a perspective view a gear 600 with external drains 602A-G along the upper surface of the gear 136 that is attached to the counterweight 138 and the eccentric 116. The external drains 600A-G are positioned to receive fluid from the fluid channels 122 of the eccentric 116 and direct the lubricant outwardly as the gear 136 rotates. In some examples, the drains 600A-G are positioned along one half of the upper side of the gear 136. For instance, the drains 600A-G may be positioned to be on the side of the gear 136 that is attached to the wider side of the eccentric barrel 118 through which fluid channels 122A-C in the eccentric 116 are located. In other examples, the drains 600A-G are positioned around the upper side of the gear 600 in an equidistant manner.

In some examples, the gear 600 also includes various holes 149A-I for receiving fasteners (e.g., bolts, pins, keys, or the like) that secure the counterweight 138, or an intermediary, to the gear 136. Additionally, the gear 600 may also include holes 137A-G for securing the eccentric 116 to the gear 600. Also, though not shown, the gear 600 may include teeth for integrating with the drive pinion 320 and holes underneath for securing the thrust bushing 134.

It is understood that variations may be made in the foregoing without departing from the scope of the disclosure. The elements and teachings of the may be combined in whole or in part in some or all of the illustrative exemplary embodiments. In addition, one or more of the elements and teachings of the various illustrative examples and embodiments may be omitted, at least in part, or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” “atop,” “underneath,” etc., are for the purpose of illustration only and do not limit the specific orientation or location of the structure described above.

In several exemplary embodiments, while different steps, processes, and procedures are described as appearing as distinct acts, one or more of the steps, one or more of the processes, or one or more of the procedures may also be performed in different orders, simultaneously or sequentially. In several exemplary embodiments, the steps, processes or procedures may be merged into one or more steps, processes or procedures. In several exemplary embodiments, one or more of the operational steps in each embodiment may be omitted. Moreover, in some instances, features of the present disclosure may be employed without a corresponding use of the other features. One or more of the examples disclosed above, or variations thereof, may be combined in whole or in part with any one or more of the other exemplary embodiments described above, or variations thereof.

The term “exemplary,” as used herein, means an example embodiment, not any sort of preferred embodiment the embodiments disclosed are exemplary only and are not limiting, and those skilled in the art will readily appreciate that many other modifications, changes, and substitutions are possible in the exemplary embodiments without materially departing from the novel teachings and advantages of the present disclosure. Accordingly, all such modifications, changes, and substitutions are intended to be included within the scope of this disclosure as defined in the following claims. In the claims, means-plus-function clauses are intended to cover the structures described herein as performing the recited function and not only structural equivalents, but also equivalent structures.

1. An eccentric assembly for providing oscillating rotation within a crusher, the eccentric assembly comprising:
a gear rotatable by force supplied from a motor;
an eccentric affixed to the gear having an eccentric barrel with a wider barrel portion and a narrower barrel portion; and
a counterweight affixed to the gear on a same side that the eccentric is affixed,
wherein the gear, the eccentric, and the counterweight are positioned around a central rotational axis of the crusher.

2. The eccentric assembly of claim 1, wherein the eccentric comprises a first set of one or more fluid channels for receiving lubricant and conveying the lubricant to the gear.

3. The eccentric assembly of claim 2, wherein the fluid channels are internal to the eccentric.

4. The eccentric assembly of claim 2, wherein the gear comprises a second set of one or more fluid channels for dispelling the lubricant received from the eccentric.

5. The eccentric assembly of claim 4, wherein an aggregate fluid channel is disposed through the eccentric and the gear.

6. The eccentric assembly of claim 5, wherein the aggregate fluid channel is configured to the dispel the lubricant vertically down the eccentric and out of one or more fluid channel outlets of the gear.

7. The eccentric assembly of claim 1, further comprising:
a feed plate assembly of the crusher having a first width; and
a socket liner attached to the feed plate assembly having a second width greater than the first width of the feed plate assembly

8. The eccentric assembly of claim 1, further comprising a thrust bushing attached to an opposite side of the gear than a side where the eccentric is attached.

9. The eccentric assembly of claim 1, wherein the eccentric is affixed to the gear using at least one member of a group comprising pins, bolts, or keys.

10. A crusher, comprising:
a hopper for receiving rock material to crush;
a bowl within the hopper;
a mantle for applying necessary pressure to the rock against the bowl; and
an eccentric assembly for providing rotational force to create an oscillating crushing force
between the mantle and the bowl, wherein the eccentric assembly comprises:
a gear rotatable by force supplied from a motor,
an eccentric affixed to the gear, and
a counterweight affixed to the gear on a same side that the eccentric is affixed.

11. The crusher of claim 10, wherein an aggregate fluid channel is disposed through the eccentric and the gear for conveying lubricant through the crusher.

12. The crusher of claim 10,
wherein the eccentric comprises an eccentric barrel and an eccentric flange; and
wherein the aggregate fluid channel comprises a first fluid channel disposed through the eccentric barrel and the eccentric flange of the eccentric, into an upper side of the gear to which the eccentric is affixed, through the gear, and out of the gear.

13. An eccentric assembly for providing oscillating rotation within a crusher, the eccentric assembly comprising:
a gear rotatable by force supplied from a motor, the comprising a first fluid channel disposed within the gear; and
an eccentric attached to the gear having a second fluid channel,
wherein an aggregate fluid channel comprising the first fluid channel of the gear and the second fluid channel of the eccentric upon attachment of the eccentric to the gear.

14. The eccentric assembly of claim 14, wherein the eccentric comprises an eccentric barrel with one wide side and one narrow side, wherein the second fluid channel is disposed within the wide side of the eccentric barrel.

15. The eccentric assembly of claim 14, wherein the gear comprises one or more drains for receiving lubricant from the second fluid channel of the eccentric and dispelling the lubricant away from the gear.
